(19) United States
(12) Patent Application Publication
(10) Pub. No.: US 2008/0055725 A1
(43) Pub. Date: Mar. 6, 2008

(54) Vehicle Reflector

(76) Inventor: David M. Dornbos, Centennial, CO (US)

Correspondence Address: Leyendecker & Lemire, LLC, C/O PORTFOLIO IP, P.O. BOX 52050, MINNEAPOLIS, MN, 55402, US

(21) Appl. No.: 11/468,903

(22) Filed: Aug. 31, 2006

(51) Int. Cl. G02B 5/136

(52) U.S. Cl. 359/548; 359/546

(57) ABSTRACT

An embodiment of a vehicle reflector comprises a prismatic lens and a vehicle coupling mechanism adapted to couple the lens to a vehicle. Typically, the reflector also includes a substrate, the prismatic lens being substantially permanently coupled to the substrate and the substrate is additionally permanently coupled to the vehicle coupling mechanism. The vehicle coupling mechanism may detachably couple the reflector to a vehicle coupling surface. The vehicle coupling surface is typically a rear-facing surface located between a tailgate and the rear bumper.

### FIELD OF THE INVENTION

This invention generally relates to vehicle reflectors.

### BACKGROUND

Persons oftentimes park their vehicles and trailers alongside roads and highways. For example, many construction workers park their trucks and vehicles along roads and highways when a construction project occurs along or near a road or highway. Typically, a construction worker parks his car along the shoulder, or if the road does not have a shoulder, simply along the side of the road. Additionally, persons often park along the side of roads and highways in cases of emergency when their vehicle is temporarily out-of-service, or when attending an event, such as a concert, at a remote location that does not provide adequate parking at the event site. In each of these situations, and in other situations involving stationary vehicles along the side of roads and highways, there is an increased potential for an accident.

When a vehicle or trailer, such as an automobile or pick-up truck, is left along the side of a road, there is a possibility than an unsuspecting driver may accidentally or negligently veer off the road and strike the vehicle. This possibility is increased at dusk, dawn, and nighttime, due to the decreased visibility from the diminution of light during those times. However, alerting drivers of vehicles approaching automobiles parked along roads or highways of the automobile's presence may decrease the possibility that one of these incidences will occur If a driver of an approaching vehicle is alerted to the vehicles presence in a substantially striking manner, the driver would be more likely to steer around the vehicle.

Prior art has not adequately answered the need to alert oncoming traffic of a vehicle's presence alongside a road or highway. For example, the prior art of unlit taillights on the rear of vehicles do not provide an oncoming vehicle with an adequate reflection such that the driver of the oncoming vehicle would be aware that a pick-up truck or other automobile is on the side of the road, especially with different types of trailers. Additionally, prior art does not teach applying a highly reflective substance to a portion of a vehicle in a manner that will alert oncoming traffic to the presence of a vehicle located alongside a road or highway. For instance, U.S. Pat. No. 5,852,400 only describes a reflector that is placed on an inner side surface of a rear cargo van door, such that when the cargo van doors are in the open position, the light-reflector may face oncoming traffic. The invention described in the '400 patent is only visible to approaching vehicles if the cargo van doors are open. Since the prior art in the '400 patent is only visible upon opening the cargo van doors, the reflector can not be used as a decorative reflector system on an outer vehicle surface.

Other prior art, such as U.S. Pat. No. 5,523,923, employs an electronic lighting device on the outside of a vehicle. However, this type of prior art is a system that illuminates the outside of vehicles, and is typically cumbersome to install—often requiring installation by an automotive body or repair professional. These systems are also very costly, especially when the installation costs are included. Prior art such as the '923 patent does not reflect light from an approaching vehicle's headlamps and does not alert oncoming traffic to the vehicle's presence if the device is not powered on. Even if prior art such as that described in the '923 patent is present in a vehicle parked alongside a road or highway and is powered on, a vehicle traveling towards the parked vehicle may not see the vehicle since there is no reflective quality present in the device.

### SUMMARY OF THE DRAWINGS

FIG. 1A is an isometric view of one embodiment of the invention.

FIG. 1B is a cut-away close-up front view of a highly prismatic lens of one embodiment of the invention.

FIG. 2 is a cross-sectional side view of one embodiment of the invention.

FIG. 3 is a bottom view of one embodiment of the invention.

FIG. 4 is a cross-sectional side view of a highly prismatic lens according to one embodiment of the invention.

FIG. 5A is an isometric view of one embodiment of the invention coupled to the rear end of a pick-up truck.

FIG. 5B is a close-up of a portion of one embodiment of the invention coupled to the rear end of a pick-up truck.

FIG. 6A is a front view of one embodiment of the invention.

FIG. 6B is a close-up front view of the hook section integration to the main body section of one embodiment of the invention.

FIG. 6C is a side view of a cutaway of the hook section and a portion of the main body section in one embodiment of the invention.

FIG. 7A is a cut-away side view showing a substrate notch of one embodiment of the invention.

FIG. 7B is an isometric bottom view of one embodiment of the invention showing the use of the substrate notch to snap the main body section into two main body sections.

FIG. 8 is an isometric view of one embodiment of the invention showing the invention coupled to a trailer.

### DETAILED DESCRIPTION

One embodiment of the invention contemplates coupling a prismatic reflector to a vehicle coupling area such as, but not limited to, the rear end of a vehicle in order to alert oncoming automobiles of the vehicles presence when the vehicle is parked alongside a road or highway. The prismatic vehicle reflector may be comprised of a highly prismatic lens or may be a retroreflector. A typical vehicle employing such a device may be a pick-up truck, as many pick-up trucks are used in the construction business, and therefore pick-up trucks are often parked along roads and highways. However, embodiments are contemplated that couple to other types of vehicles. For example, an embodiment is contemplated to couple to the end of a trailer, or for other construction equipment, or for recreational equipment such as campers and recreational vehicles (“RVs”).

One embodiment is typically adapted to couple to an outwardly facing rear surface of a vehicle. A rear surface of a vehicle is often used as a vehicle coupling surface to maximize safety since the rear of the vehicle oftentimes faces oncoming traffic. For example, in one pick-up truck embodiment, the embodiment is placed on the rear of a pick-up truck above the bumper and below the tailgate. In one trailer embodiment, the embodiment may be coupled to the rear trailer bumper or to an outwardly facing rear surface of the trailer frame. One other vehicle embodiment may be adapted to couple to a rear vehicle bumper or another rear vehicle surface.

In many pick-up trucks, the vehicle coupling area is a space on an outwardly facing rear panel between the top of the bumper and the bottom of the tailgate. One embodiment is adapted to fit within this vehicle coupling area on various makes and models of pick-up trucks, the area typically comprising a portion of the rear molding or rear body panel. In an embodiment, the vehicle coupling area is visible from the rear of the pick-up truck and typically spans from the outer passenger side of the truck bed to the outer driver side of the truck bed. In pick-up trucks that do not possess a vehicle coupling area between the bumper and tailgate, one embodiment may be placed on the rear bumper or the bottom of the tailgate. Alternatively, one embodiment may be adapted to couple to a vehicle coupling surface which is an outer surface of a vehicle other than a pick-up truck, such as the outer surface of a trailer or RV, as described earlier.

One embodiment is typically generally 1 inch wide and 60 inches long. An embodiment is also 6 inches long and one inch wide. One embodiment length is any length from 6 to 60 inches, in six inch increments. An embodiment may vary in length and width for different makes and models of vehicles or trailers, with a most preferred larger width being a 3 inch width, and a most preferred smaller width being a ½ inch width.

One embodiment's substrate has at least one notch in the rear surface. The notch is typically generally 54 inches from an embodiment end and is adapted to shorten the length of the embodiment from about 60 inches to about 54 inches by snapping off about a 6 inch portion of the embodiment's main body section.

One embodiment's prismatic lens typically couples to a substrate. The lens and substrate typically have the same general shape. The prismatic lens typically has a lens front surface and a lens back surface, and a typical substrate has a substrate front surface and a substrate back surface. The front surface of both the lens and substrate typically generally oppose the back surface of the lens and substrate, respectively. In some embodiments, the prismatic lens may be a retroreflector.

The highly prismatic lens and coupled substrate in at least one embodiment are each shaped as a long rectangular cube, with the back surface of the highly prismatic lens being substantially permanently coupled to the front surface of the substrate. The lens and substrate are typically coupled through a thin double-sided adhesive film. In one embodiment, the back surface of the substrate is typically coupled to a coupling mechanism, such as magnets or a hook-loop material such as Velcro™, which is adapted to detachably couple the reflector to the vehicle. The coupling mechanism may also not allow the embodiment to detachably couple to the vehicle, but may be a mechanical coupling mechanism adapted to substantially permanently couple the embodiment to a vehicle coupling surface. One type of a substantially permanent coupling mechanism may be a bolted assembly or a double-sided adhesive such as a double-sided tape.

Whatever type of coupling mechanism is used, in one embodiment, the coupling mechanism typically couples the reflector to the vehicle coupling area such that the front surface of the highly prismatic lens typically faces outwardly from the vehicle rear end, generally reflecting the headlights of vehicles approaching the rear of the vehicle. The highly prismatic lens may be a colored lens such as, but not limited to, a white, yellow, or fluorescent orange highly prismatic lens. In one embodiment, multiple different colored lenses are used. One embodiment may be a decorative embodiment. A decorative embodiment may display designs such as, but not limited to, flags, written phrases, figures, or advertisements.

One embodiment may also be comprised of a prismatic lens and underlying substrate, or the embodiment may have a different type of reflector, such as an opaque reflector. Further, the color of the lens on one embodiment may be adapted to match the paint or accent color of the vehicle on which it is to be mounted. Whatever the design of the embodiments, there is essentially no limit to the type of designs that may be created with whatever type of reflector or substrate that is used.

Some embodiments may be configured for use on any portion of the vehicle's outer surface, not simply the rear body panel area. For example, embodiments may be placed on a vehicle surface such as, but not limited to, a vehicle front bumper, or on a portion of a vehicle hood that faces oncoming traffic from the front of the vehicle, on a wheel-well covering, or on a trailer frame.

### Terminology:

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “retroreflect,” including all variances such as, but not limited to “retroflector,” “retroreflection,” and “retroreflective,” as used in this specification and the appended claims refers to the ability of a device to return light to its origination point, regardless of the angle of incidence.

The term “entrance angle” as used in this specification and the appended claims is the incidence angle, or the angle from the illumination axis to the retroreflector axis or highly prismatic lens axis. The “retroreflector axis” or “highly prismatic lens axis” is an axis perpendicular to the front surface of the retroreflector or highly prismatic lens.

The term “observation angle” as used in this specification and the appended claims is the angle between the illumination axis and the observation axis.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “couple” or “coupled” as used in this specification and the appended claims refers to either an indirect or direct connection between the identified elements, components or objects. Often the manner of the coupling will be related specifically to the manner in which the two coupled elements interact.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

The term “integrate” or “integrated” as used in this specification and the appended claims refers to a blending, uniting, or incorporation of the identified elements, components or objects into a unified whole.

### First Embodiment of a Decorative Vehicle Reflector

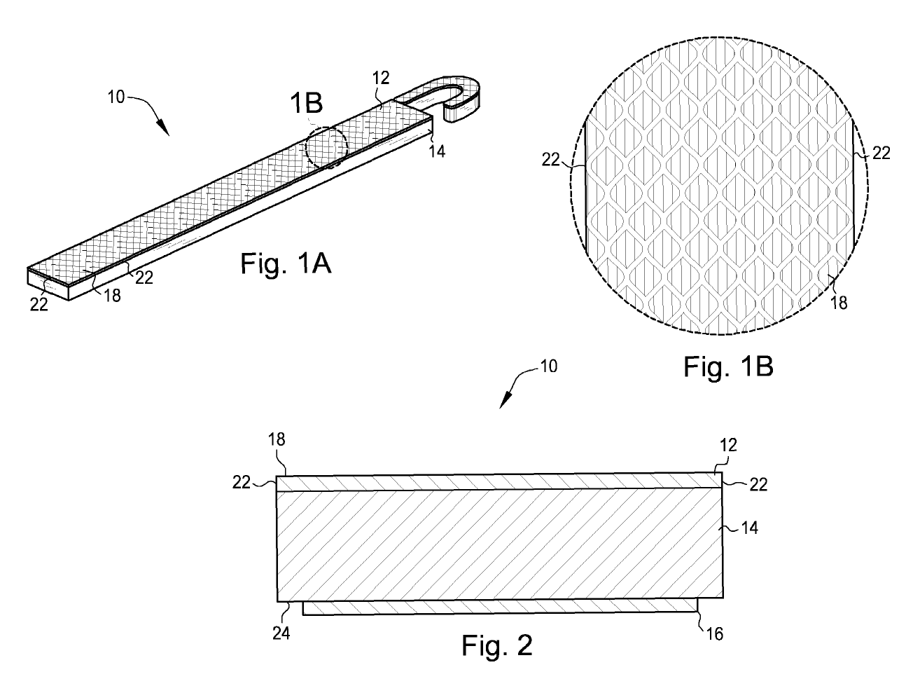

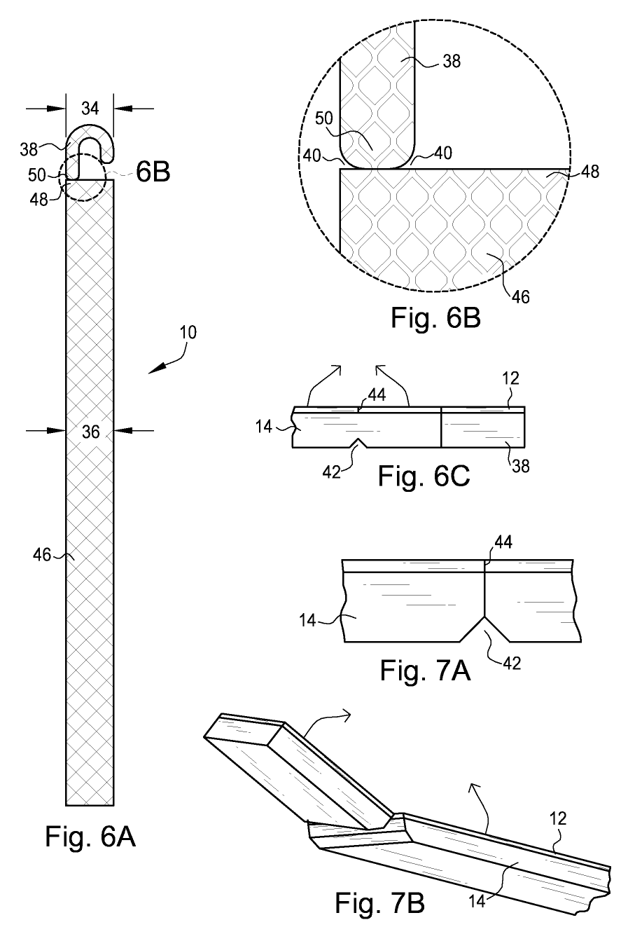

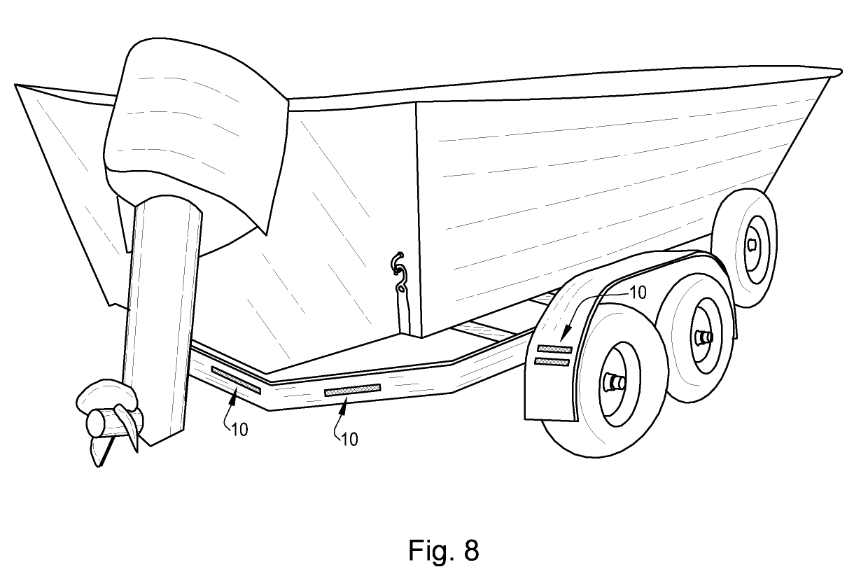

Referring to FIGS. 1 through 7B, an embodiment of a vehicle reflector 10 is illustrated. In one embodiment, the reflector is comprised of a highly prismatic lens 12 and a vehicle-coupling mechanism 16. One embodiment also includes a substrate 14. The highly prismatic lens may be a retroreflector. One embodiment's highly prismatic lens is best shown in FIGS. 1A and 6A.

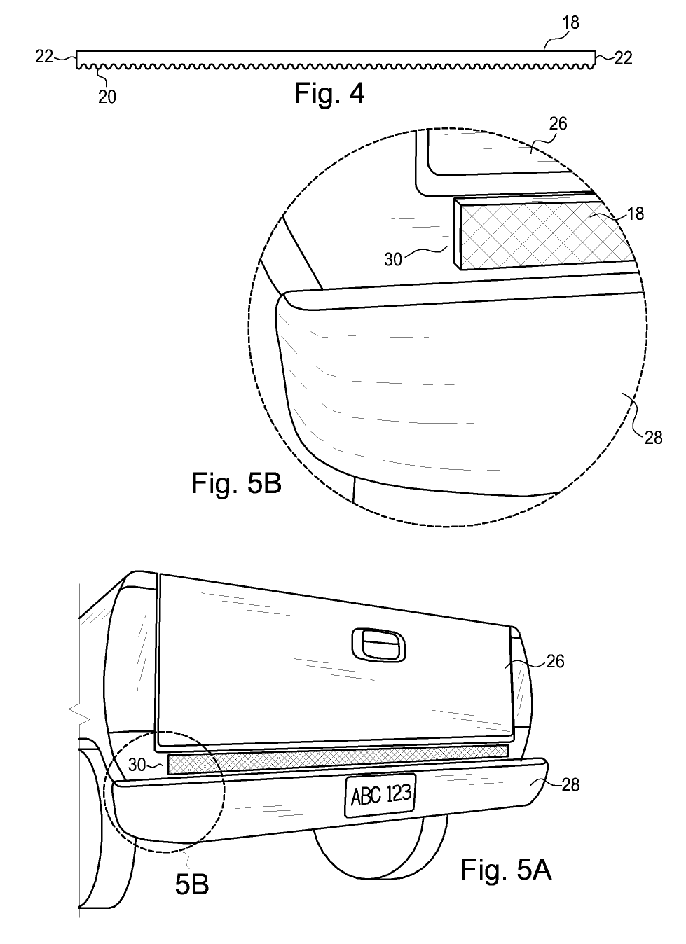

The highly prismatic lens 12 in certain embodiments is typically comprised of at least one lens front surface 18 and at least one lens back surface 20, as shown in FIG. 4. A lens front surface typically has a general honeycomb-like appearance, as best shown in FIG. 1B. The honeycomb appearance of the lens front surface may be due to an adhesive which couples the lens back surface to the substrate front surface. The lens front surface is typically a flat, smooth surface, as best shown in FIG. 4. One embodiment may also include a lens that is coupled to the vehicle directly through a vehicle attachment mechanism.

The highly prismatic lens 12 in one embodiment is typically a generally transparent plastic lens that includes four side surfaces 22. The highly prismatic plastic material may be a material such as, but not limited to, polymethyl methacrylate. However, in other embodiments, the highly prismatic lens may be comprised of an alternative polymeric material or even a non polymeric material. Opaque materials such as, but not limited to, a ceramic, metal, or a composite material may be used in alternative embodiments with a highly prismatic coating being placed on the material.

The highly prismatic lens in one embodiment is typically shaped as a rectangular lens. Therefore, two of the four side surfaces 22 of one embodiment's highly prismatic lens 12 are generally parallel and perpendicular to the two other of the four side surfaces of one embodiment's highly prismatic lens. The side surfaces extend from the front surface 18 to the back surface 20, as best shown in FIG. 4.

Also as best shown in FIG. 4, the lens back surface 20 in one embodiment is typically comprised of a plurality of grooves, the grooves typically being Generally parallel to two side surfaces 22 in one embodiment. Each groove is typically a prismatic groove adapted to create the reflective effect of the lens. Alternative prismatic lens embodiments may not be comprised of a back surface with a plurality of grooves or the grooves may not be prismatic grooves adapted to create a reflective effect.

In one embodiment comprising a lens back surface with grooves, the grooves are typically either substantially vertically oriented when coupled to a vehicle or substantially horizontally oriented when coupled to the vehicle. Other embodiments may include highly prismatic lenses 12 with back surface 20 grooves that are neither substantially vertically nor horizontally oriented when the embodiment is coupled to the vehicle. However, placing the grooves of the highly prismatic lens back surface in a substantially vertical position typically provides the greatest illuminance at the widest entrance angles. For example, at entrance angles greater than 40 degrees, the decorative vehicle reflector with generally vertically-aligned grooves will typically provide greater illuminance to a driver of an approaching vehicle than an embodiment with generally horizontally-aligned grooves.

In addition to having a grooved back surface, the lens 12 is typically coupled to the substrate 14 with an adhesive applied to the lens back surface 20 in a substantially honeycomb pattern. Alternative coupling patterns such as, but not limited to, a diamond pattern may be used. One embodiment may not include an adhesive with a pattered coupling mechanism.

Often, an adhesive comprising a pattern is used to couple the lens 12 to the substrate 14 (instead of, for example, a flat adhesive sheet or liberally applied liquid adhesive) so that the adhesive only fills in a portion of the back surface 20 grooves and does not substantially fill in the entire back surface prismatic grooves. However, in one embodiment, the adhesive pattern may be applied as an adhesive sheet with only the actual adhesive honeycomb pattern coupling to the lens back surface. Any adhesive used typically does not significantly hinder the reflective qualities of the prismatic lens. Other embodiments may incorporate highly prismatic lenses 12 that do not have a honeycomb look to the front surface 18.

Unlike the honeycomb adhesive attachment to the lens back surface 20, which is visible upon casual examination of the lens front surface, the grooves in the lens back surface are typically not readily apparent by casual visual examination of the lens front surface. However, upon careful examination of the lens front surface, usually at a distance of 12 to 18 inches, the grooves in the lens back surface may readily be seen. Additionally, the lens may be a clear lens, or may be a colored lens.

If the lens 12 is a colored lens, the color may be either substantially similar to a vehicle color, or the lens may be a color generally different than a color of the vehicle. It is to be appreciated that different colored lenses may also be used in embodiments to create a decorative or increased safety display on an outer vehicle surface. Multiple colors may be used in one embodiment. Any display will still typically have general reflective qualities as described herein.

The typical thickness of the highly prismatic lens in certain embodiments is generally 10 mils. However, the thickness may be less than or greater 10 mils, such as a lens with a thickness that is 5 mils or 15 mils. A type of lens that may be used in one embodiment that generally has the qualities as described herein is the Series 3990 Diamond Grade™ VIP Reflective Sheeting, supplied by 3M Corporation of St. Paul, Minn. However, alternative highly prismatic reflective lens sheeting may be used. Although other highly prismatic reflective lens or retroreflective sheeting may not possess the honeycomb appearance or have a generally grooved rear surface, the maximum entrance angle of any lens used on one embodiment is typically not less than 40 degrees.

For example, a highly prismatic lens 12 used in one embodiment provides relatively high illuminance across a wide range of entrance angles. For an entrance angle substantially being 4 degrees, with an observation angle substantially being 0.2 degrees, a typical yellow highly prismatic lens may a minimum coefficient of retroreflection of 300, as determined in accordance with ASTM E-810 “Test Method for Coefficient of Retrorefleciton of Retroreflective Sheeting.” However, other embodiments may include highly prismatic tenses possessing a minimum coefficient of retroreflection that is greater than or less than 300 at a 4 degree entrance angle and a 0.2 degree observation angle. At a 40 degree entrance angle, the embodiment may only have a coefficient of retroreflection of 70. Similarly, with entrance angle of 4 degrees, an embodiment employing white highly prismatic lens may have a minimum coefficient of retroreflection that is generally 570, or an embodiment with a blue highly prismatic lens may have a minimum coefficient of retroreflection that is generally 22.

Whatever the reflective qualities of the highly prismatic lens 12, the lens back surface 20 in one embodiment is typically substantially permanently coupled to the substrate 14 front surface. In one embodiment, the lens and substrate are typically coupled in such a manner that will last for a minimum of two years under typical weather conditions. However, depending on the circumstances, the substrate/lens bond may last longer than, or shorter than, 2 years. One embodiment's lens/substrate coupling may last for as long as 5 years, 10 years, or greater.

Typically, the lens back surface 20 and the substrate 14 front surface are coupled using an adhesive such as, but not limited to, a double-sided adhesive tape. Alternative adhesives such as, but not limited to, liquid adhesives, paste adhesives, or a pressure sensitive adhesive may be used. Pressure sensitive adhesives create a bond simply by the application of light pressure. Often, the type of adhesive used to couple the lens to the substrate is dependent upon the substrate material and the lens material.

In one embodiment, the back surface 20 of the highly prismatic material 12 has the same general shape as the front surface of the substrate 14, For example, since the typical lens back surface is generally rectangular, the substrate front surface in one embodiment is also typically generally rectangularly shaped. In one embodiment, the substrate is typically shaped as a long thin cube.

In one embodiment, the front surface of the substrate 14 and the back surface 20 of the highly prismatic lens 12 typically possesses the same general dimensions. However, in other embodiments that employ a substrate, the front surface of the substrate may couple to the back surface of multiple highly prismatic lenses. In other embodiments having multiple highly prismatic lenses, each prismatic lens may be a different color. In such an embodiment, each prismatic lens back surface would likely couple to only a portion of a substrate front surface, but each prismatic lens may also couple to separate individual substrate front surfaces, respectively.

In one embodiment, the substrate 18 is typically generally 0.20 inches thick, 1 inch wide and 60 inches long. The highly prismatic lens is therefore also typically 1 inch wide and 60 inches long. The dimensions and general cube shape are only very general guidelines, with other embodiments' dimensions being adapted for use with different vehicles. In some embodiments, the thickness of the substrate may be only about 0.10 inches thick, or the thickness may be up to 0.50 inches thick. Some different embodiments, for example, may have stylishly designed substrates and matching highly prismatic lenses. Additionally, some embodiments may not have a substrate or may have an integrated substrate.

An embodiment may also be comprised of a substrate 14 that is substantially a 6 inch long substrate. A six inch long substrate will typically be coupled to a lens 12 that is substantially 6 inches long as well, although in alternative embodiments, a smaller, or possibly even a longer, lens may be used. A 6 inch embodiment is typically still used as a safety device, similar to the 54 and 60 inch embodiments. One 6 inch embodiment may be coupled to a vehicle in conjunction with additional 6 inch embodiments. When a multiple 6 inch embodiment is coupled to a vehicle, each 6 inch section may be a different color. Additionally, one embodiment is adapted to be coupled to a vehicle in any length from 6 inches to 60 inches, so long as the length is in six-inch increments.

The substrate in at least one embodiment is typically comprised of an injection-molded plastic material. However, in other embodiments, the substrate may not be injection molded and may be vacuum molded or cut from sheet material. Different types of plastics may be used in a particular embodiment. Examples of plastics include fiberglass reinforced plastic, acrylic, plexiglass, acrylonitrile butadiene styrene (ABS), polyvinyl chloride (PVC), polypropylene, polycarbonate, polystyrene, or polyethylene. In some embodiments, plastic composites and non-plastics may be used as well. For example, a metal material such as aluminum or steel may be used as the substrate material. Additionally, plywood and wood products may be used as a substrate material in yet other embodiments. Whatever type of substrate material is used, the substrate material should typically be adequately cleaned prior to substantially permanently coupling the lens to the substrate.

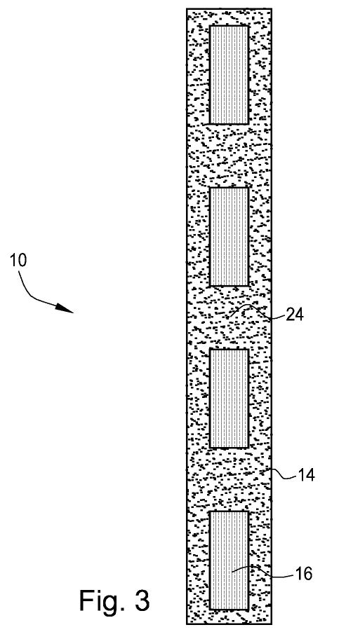

Whatever the substrate material, the typical embodiment is comprised of a substrate 14 having a back surface 24. The back surface of the substrate is typically coupled to a coupling mechanism 16, the coupling mechanism being adapted to detachably couple the decorative vehicle reflector 10 to a vehicle coupling surface 30. In other embodiments, the substrate may be integrated to the coupling mechanism. Additionally, the back surface of the substrate may be a textured surface, as shown in FIG. 3.

The back surface 24 of the substrate 14 is typically substantially the same shape as the front surface of the substrate in one embodiment. Therefore, if the front surface has a generally rectangular shape, the back surface will also have a rectangular shape of substantially the same dimensions. However, in other embodiments, the back surface may not have the same shape or may not have the same dimensions as the front surface.

In one embodiment, the coupling mechanism 16 may be comprised a hook-loop material such as Velcro™. However, alternative coupling mechanisms may be employed. These alternative coupling mechanisms may be items such as, but not limited to, magnets or a pressure sensitive adhesive.

As shown in FIGS. 5A and 5B, one embodiment is adapted to be placed on a vehicle coupling surface 30 between the rear bumper and the tailgate of a pick-up truck. Typically, a pick-up truck's rear body panel section is the vehicle coupling surface, the panel section facing outwardly from the vehicle rear end. However, the embodiment may not be coupled on a rear body panel, but may be coupled either to the rear bumper 28 or tailgate 26 itself. Additionally, an embodiment may be placed on other vehicle surfaces. One alternative embodiment may even be placed on the inside of a vehicle window.

One embodiment is also adapted to couple to a trailer. In a trailer embodiment, the embodiment is adapted to couple to an outwardly-facing surface of the trailer. For example, one embodiment is adapted to couple to an outwardly-facing surface on the rear of the trailer. The rear surface may be the rear bumper, or the surface may be a tailgate or other outwardly facing rear surface. An embodiment is adapted to couple to any type of trailer, such as a boat trailer, snowmobile trailer, or horse trailer. Additionally an embodiment is adapted to couple to other vehicles as well. In one embodiment, the reflective strip is adapted to couple to a van, a bus, a camper, an RV, or construction equipment such as a Bobcat™ loader.

An embodiment adapted to couple to various types of vehicles and trailers may be a 54 or 60 inch embodiment or may be a shorter embodiment. For example, in one 6 inch embodiment is adapted to couple to an outwardly facing rear surface or a trailer. An embodiment greater than 6 inches is also adapted to couple to an outwardly facing surface of a bus, whether the surface is a rear surface or otherwise.

In one embodiment using a hook-loop coupling material such as Velcro™, sections of either the hook portion or the loop portion of the coupling mechanism are coupled to the back surface 24 of the substrate 14, as shown in FIGS. 2 and 3. Similarly, sections of either the hook portion or the loop portion are coupled to the vehicle coupling surface such that each hook-loop portion on the back surface of the substrate are adapted to correspondingly align with an opposing hook-loop portion on the vehicle rear body panel in one embodiment. The hook-loop portions of the Velero™ in one embodiment are typically coupled to the vehicle coupling surface 30 and the back surface of the substrate with an adhesive, the adhesive typically being a liquid adhesive or a double-sided adhesive tape.

An embodiment may also be comprised of a coupling mechanism 16 such as a double-sided adhesive tape. Typically, the tape substantially permanently couples the embodiment to a vehicle coupling surface 30. However, an embodiment may have a different substantially permanent coupling mechanism as well, such as, but not limited to, a bolt-nut assembly. As discussed previously, an additional embodiment may be comprised of a coupling mechanism adapted to detachably couple the embodiment to an outer vehicle surface such as, but not limited to, Velcro™ or a magnetic coupling mechanism.

As shown in FIGS. 6A, 6B, and 6C, a typical embodiment may also include a hook section 38. Typically not incorporated into the use of the embodiment to provide illuminance, the hook section is typically adapted to allow a retailer to hang the embodiment such that the embodiment may be easily displayed to the retailer's customers. However, the hook section may be used as a portion of the embodiment to provide illuminance in some embodiments. In other variations, the substrate may include a bore or an opening at one end to permit the reflector to be hung from a retailer's hook.

The hook section width 34 is typically generally equal to the width 36 of the main body section 46 of the reflector 10, although in other embodiments the hook section may be wider than, or not as wide as, the main body section of the embodiment. The hook section 38 is typically coupled to the embodiment at an embodiment proximal end 48, with a distal end 50 of the hook section typically having two hook notches 40. However, the hook section may be coupled to another area of the embodiment, such as the center of the main body section of the reflector.

The hook section 38 may be comprised of only a substrate 14, or the hook section may also include a highly prismatic lens 12. In the typical embodiment, the hook only includes the substrate, the hook substrate typically being integrated to the main body section 46 substrate. However, there is typically a substrate notch 42 in the substrate back surface where the hook section substrate is integrated to the main body section substrate. Additionally, if the hook section includes a highly prismatic lens, the hook's highly prismatic lens would typically not be integrated with the main body section's highly prismatic lens, but in other embodiments it may, or it may have a cut similar to the cut 44 in the prismatic lens correspondingly aligned with any main body substrate notch 42.

As shown in FIGS. 7A and 7B, there is also typically an additional substrate notch 42 in the main body section substrate 14 and a correspondingly aligned cut 44 in the highly prismatic lens 12. The substrate notch in the main body section is typically located 54 inches from an embodiment end. The substrate notch 42 and cut 44 are adapted to allow the main body section 46 be split into separate main body sections. Similarly, the hook notches 40 and the substrate notch 42 in the hook section substrate back surface are adapted to allow the hook to be “snapped” or “broken” off the main body 46 section of the embodiment. The hook section is typically snapped off by bending the top surface of the hook towards the top surface of the main body section. However, alternative motions may be used to snap the hook off of the main body section, such as, but not limited to, a twist motion.

As shown in FIG. 7B, to breach the main body section 46 into multiple main body sections, force is applied to the substrate 14 back surface on each side of the substrate notch 42, attempting to force the front surface 18 of the highly prismatic lens 12 on each side of the notch to touch. Such a motion is typically used to separate the embodiment into two main body sections. In some embodiments, the substrate and prismatic lens of the main body section 46 may contain a substrate notch in a different location, or may be comprised of more than one substrate notch and cut 44, respectively, or the force required to separate the main body section into multiple main body section may be different.

### One Method of Coupling a Vehicle Reflector to a Vehicle Coupling Surface

With reference to FIGS. 1A, 3, and 5 through 7, a method of coupling a vehicle reflector to a vehicle coupling surface in order to alert a driver of a vehicle's presence is described herein. The vehicle reflector 10 is typically comprised of a substrate 14 and a coupled highly prismatic lens 12. The highly prismatic lens typically has a back surface that is coupled to a substrate front surface.

The first step in the typical method is to locate a vehicle coupling surface 30. The vehicle coupling surface is typically a surface on the outside of a vehicle. However, alternative vehicle coupling surfaces may be a surface on the inside of a vehicle, such as the inside of a window. The vehicle coupling surface in one method is an outwardly facing rear body panel surface between the tailgate and the bumper, as best shown in FIGS. 5A and 5B. Other vehicle coupling surfaces on vehicles such as, but not limited to, trailers, may be used. A trailer vehicle coupling surface may be a rear bumper or other outer surface. In a typical method, a rear-facing surface is used, however, in other embodiments, non rear-facing vehicle coupling surfaces may be used.

Once the vehicle coupling surface 30 is determined, the vehicle coupling surface is typically cleaned. Cleaning typically includes ensuring the surface is generally free of debris such as dirt, dust, and oil. A typical cleaning process may simply include wiping down the vehicle coupling surface with a wet rag. For dirtier surfaces, or surfaces having an oil-based substance on the surface, more than a wet rag will typically need to be used to clean the surface. Soap or specialized car-cleaning supplies may be used to clean the surface. For example, General Purpose Adhesive Cleaner, Part No. 051135, produced by 3M, Inc., of St. Paul, Minn. adequately removes road tar, grease, oil, adhesive, new car cosmoline, wax, and other contaminants. Finally, the surface is dried.

Upon having a clean and dry vehicle coupling surface 30, the vehicle reflector 10 is coupled to the vehicle coupling surface with a coupling mechanism 16. Typically, the coupling mechanism is coupled to the back surface 24 of the substrate 14. For example, in one method, the vehicle reflector is coupled to the vehicle coupling surface with a hook-loop coupling mechanism. The hook-loop coupling mechanism typically used is Velcro™.

A substantially permanent coupling mechanism 16 may be used in one method. For example, a coupling mechanism such as, but not limited to, double-sided adhesive tape or a bolted assembly may be used to couple an embodiment to a vehicle coupling surface 30. Typically, in one embodiment, however, the vehicle coupling mechanism is adapted to detachably couple the embodiment to the vehicle. A detachable coupling mechanism typically allows an embodiment to repeatedly attach and detach to a vehicle coupling surface. A hook-loop coupling mechanism such as Velcro™ is one type of detachable coupling mechanism that may be used.

In using Velcro™ to couple the vehicle reflector 10 to the vehicle coupling surface 30, separate and distinct hook or loop patches are typically coupled to the back surface 24 of the substrate 14, as best shown in FIG. 3. Typically, the coupling mechanism such as the Velcro™ patches are placed on the back surface of the substrate by the user, but in alternatives, the substrate back surface may include an integrated vehicle coupling mechanism 16 or may include a factory-coupled vehicle coupling mechanism.

In the typical method, the substrate back surface 24 is not substantially entirely covered in hook-loop material. However, in other embodiments, the back surface may be substantially entirely covered in Velcro™, or another hook-loop coupling mechanism 16 may be used, or a separate type of coupling mechanism such as, but not limited to, a magnetic coupling mechanism may be used. The vehicle coupling mechanism is typically coupled to the substrate and the vehicle coupling surface with an adhesive. The adhesive may be an adhesive such as, but not limited to, a liquid adhesive or double-sided adhesive tape.

In one method, hook-loop patches are also typically placed on the vehicle coupling surface 30 by the user. The position of the hook-loop patches on the vehicle coupling surface typically correspondingly aligns with the location of the hook-loop patches on the substrate back surface 24. Therefore, when the vehicle reflector is placed on the vehicle, the patches on the substrate back surface are aligned with the patches on the vehicle coupling surface. Each corresponding patch pair is comprised of a hook material and a loop material, with the substrate back surface having either the hook or loop surface and the vehicle coupling surface having the other of the hook or loop surface.

Upon attaching the vehicle coupling mechanism 16 to the back surface of the substrate 14 and the vehicle coupling surface 30 in one method, the vehicle reflector is coupled to the vehicle. In some methods, the vehicle reflector may be coupled to the vehicle without coupling a separate surface to the vehicle coupling surface. For example, in a magnetic coupling mechanism, the vehicle reflector would simply couple to the vehicle after cleaning the vehicle coupling surface.

Upon coupling the substrate back surface 24 to the vehicle coupling surface 30, the highly prismatic lens 12 generally faces outwardly from the vehicle. When the vehicle coupling surface is proximal a bumper 28 and tailgate 26, the highly prismatic lens is substantially a rear-facing lens. However, in other methods, the highly prismatic lens may not be a substantially rear-facing lens. In an event, upon placing the highly prismatic lens on any generally outwardly-facing vehicle surface, upon light emanating from a vehicle's headlights contacting the highly prismatic lens, the lens reflects the light.

In a typical method comprising a highly prismatic lens 12 on a rear-facing vehicle coupling surface 30 between a pick-up truck tailgate 26 and bumper 28, when the rear of the vehicle faces oncoming traffic, the vehicle reflector 10 typically reflects an approaching vehicle's headlights. The highly prismatic lens may be a retroreflector and typically substantially reflects light at a maximum entrance angle of not less than 40 degrees.

In one method, the reflector 10 is comprised of a hook section 38, at least one hook notch 40, and at least one substrate notch 42. The substrate notch is typically correspondingly aligned with a lens cut 44. The hook section is typically used by a retailer to hang the reflector. A least one substrate notch is also typically located in the back surface of the hook substrate. The hook notch and the substrate notch, together with the lens cut, are designed to separate the hook section from the main body section 46 embodiment and the embodiment into two pieces.

In one method, to separate (i) the hook from the embodiment body section, and (ii) the embodiment into two body sections, a force is typically applied to each side of the respective substrate notch. As shown in FIGS. 6C and 7B, the force is applied in such a manner as to force the front surface 18 of the highly prismatic lens 12 on each side of the substrate notch 42 to touch.

If such a force is applied to each side of the substrate notch 42 attaching the hook sections, the hook is typically snapped off from the main body section 46 of the embodiment. Additionally, if such a force is applied to each side the embodiment notch, the main body section is snapped into two main body sections.

### Alternative Vehicle Reflector Embodiments

The embodiments of the vehicle reflector as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure. For instance, the embodiments are described herein primarily in relation to a vehicle reflector coupled to the rear end of a pick-up truck. It is appreciated, however, that variations may be implemented for use on all types of vehicles, such as sports cars, boats, and motorcycles.

In addition to the embodiments described herein, a variation is contemplated wherein the prismatic lens would be directly coupled to a vehicle outer surface. In such an embodiment, the vehicle surface may be used as the substrate, and an adhesive may couple the highly prismatic lens to the vehicle.

I claim:

1) A vehicle reflector comprising:
a prismatic lens, the prismatic lens including a lens front surface and a lens back surface;
a substrate comprising a substrate front surface, a substrate back surface, a length and a width; and
one or more vehicle coupling mechanisms adapted to couple the reflector to a vehicle.

2) The vehicle reflector of claim 1, wherein:
the prismatic lens being affixed to the substrate front surface, the substrate comprising a plastic material about 0.20″ to 0.50″ thick;
the one or more coupling mechanisms affixed to the substrate back surface, the vehicle coupling mechanisms adapted to facilitate the removable attachment of the prismatic lens and substrate combination to a vehicle.

3) The vehicle reflector of claim 2 in combination with a pickup truck, the pickup truck including a rear end having a rear bumper and a rear tailgate, wherein:
the prismatic lens comprises a substantially transparent colored lens adapted to reflect light having a maximum entrance angle of no less than 40 degrees;
the vehicle coupling mechanism comprising hook-loop material; and
the vehicle reflector is removably coupled to the rear end at a location substantially above the rear bumper and below the rear tailgate.

4) The vehicle reflector of claim 2, wherein the prismatic lens front surface is about 60 inches long and about 1 inch wide.

5) The vehicle reflector of claim 1 wherein, the prismatic lens comprises a retroreflector.

6) The vehicle reflector of claim 1 wherein the substrate comprises a hook section, a body section, and one or more hook notches;
the hook section being integrated to the body section and being adapted to hang the reflector; and
the one or more hook notches being adapted to separate the hook from the body section.

7) The vehicle reflector of claim 6 further including at least one substrate notch wherein,
the length of the substrate body section is about 60 inches; and
the at least one substrate notch adapted to separate the substrate body section into two body sections, the at least one notch being located about 54 inches from one end of the substrate.

8) The vehicle reflector of claim 2 wherein the length of the prismatic lens front surface is about 6 inches long.

9) A vehicle reflector comprising:
a retroreflector;
a semi-rigid plastic substrate having a thickness of more than about 0.10″, the substrate being substantially permanently coupled to the retroreflector; and
one or more coupling mechanisms; the one or more coupling mechanisms being adapted to facilitate the removable attachment of the retroreflector and substrate combination to a vehicle.

10) The vehicle reflector of claim 9 wherein the substrate comprises a body section and an integrated hook section.

11) The vehicle reflector of claim 10 wherein the body section includes one or more substrate notches.

12) The vehicle reflector of claim 11 wherein,
the hook section is adapted to break apart and detach the hook from the body section; and
the one or more substrate notches being adapted to separate the body section into 2 or more body sections.

13) The vehicle reflector of claim 9 wherein, the one or more coupling mechanisms comprise a hook-loop material.

14) The vehicle reflector of claim 9 wherein, the retroreflector is adapted to reflect light with an entrance angle of at least 40 degrees.

15) The vehicle reflector of claim 9 wherein, the thickness of the substrate is at least 3/16 inches thick.

16) A combination of a pickup truck and a reflector assembly, the pickup truck having a back end with a rear bumper and a tailgate, a top edge of the rear bumper and a bottom edge of the tailgate defining upper and lower bounds of a first surface, the reflector assembly comprising an elongated retroreflective material, the retroreflective material being coupled substantially to the first surface.

17) The combination of claim 16, wherein the reflector assembly further comprises: a semi-rigid plastic substrate material having a thickness of at least 0.10 inches, the substrate being attached to a surface retroreflector.

18) The combination of claim 17, wherein the reflector assembly further comprises one or more pairs of hook and loop material with one piece of each pair secured to the substrate and another piece of the pair secured to the first surface.

19) The combination of claim 18, wherein the length of the reflector assembly is generally the same length as the width of the back end.

20) The combination of claim 19, wherein a color of the retroreflective material is substantially the same color as a paint color of the pickup truck.
